(19) United States
(12) Patent Application Publication
(10) Pub. No.: US 2026/0348027 A1
(43) Pub. Date: Nov. 5, 2026

(54) HYDROGEN GAS PRODUCTION SYSTEM AND HYDROGEN GAS PRODUCTION METHOD

(71) Applicant: TAIYO NIPPON SANSO CORPORATION, Shinagawa-ku, Tokyo (JP)

(72) Inventors: Takumi SOMEYA, Shinagawa-ku, Tokyo (JP); Yuta TSUCHIHASHI, Shinagawa-ku, Tokyo (JP); Yusuke MIKI, Shinagawa-ku, Tokyo (JP); Yuzuru MIYAZAWA, Shinagawa-ku, Tokyo (JP); Kenji FUKUDA, Shinagawa-ku, Tokyo (JP)

(73) Assignee: TAIYO NIPPON SANSO CORPORATION, Shinagawa-ku, Tokyo (JP)

(21) Appl. No.: 19/488,612

(22) PCT Filed: Apr. 18, 2024
(86) PCT No.: PCT/JP2024/015484

§ 371 Date: Nov. 27, 2025

(30) Foreign Application Priority Data
Jun. 7, 2023 (JP) 2023-094362

(51) Int. Cl. C25B 9/19; C25B 1/04; C25B 9/60; C25B 15/08

(52) U.S. Cl. CPC C25B 9/19; C25B 1/04; C25B 9/60; C25B 15/083; C25B 15/087

(57) ABSTRACT

Provided is a hydrogen gas production system that can produce, at a high recovery rate, hydrogen gas having a deuterium D content equal to or greater than that of raw material water. A hydrogen gas production system includes a first tank to contain raw material water including heavy water, an electrolysis device configured to electrolyze the raw material water to generate a hydrogen gas, a reservoir to store the hydrogen gas, a liquid supply device, and a gas supply device. The liquid supply device is controlled to replenish the electrolysis device with the raw material water from the first tank as the amount of the raw material water remaining in the electrolysis device decreases. The gas supply device is controlled to supply the hydrogen gas to the reservoir continuously before and after replenishing of the electrolysis device, and the reservoir stores the hydrogen gas.

### TECHNICAL FIELD

The present disclosure relates to hydrogen gas production systems and hydrogen gas production methods for producing hydrogen gas by electrolyzing water.

### BACKGROUND

Stable isotopes of hydrogen atoms that make up naturally occurring water, hydrogen gas, and the like include hydrogen ¹H (hereinafter also referred to as H), which has a mass number of 1 (the atomic nucleus consists of only one proton), deuterium ²H (hereinafter also referred to as D), which has a mass number of 2 (the atomic nucleus consists of one proton and one neutron), and tritium ³H (hereinafter also referred to as T), which has a mass number of 3 (the atomic nucleus consists of one proton and two neutrons). The content ratio of D and T is overwhelmingly smaller than that of H. In the fields of semiconductor manufacturing and nuclear power, applications in which D is particularly effective are known. For this reason, there is a demand for low-cost production of water or hydrogen gas with an increased D content.

Incidentally, a commonly used method for producing hydrogen gas is electrolysis, in which water is electrolyzed to generate oxygen gas and hydrogen gas. It is known that in electrolysis, deuterium-enriched hydrogen gas (hydrogen gas having a higher content of deuterium D than ordinary hydrogen gas) can be produced by using deuterium-enriched water (water having a higher content of deuterium D than ordinary pure water) as raw material water. Patent Literature (PTL) 1 proposes a technique for generating deuterium-enriched hydrogen gas using a batch-type electrolysis device.

### CITATION LIST

### Patent Literature

PTL 1: JP H8-323154 A

### SUMMARY

### Technical Problem

However, when deuterium-enriched water as raw material water is electrolyzed to obtain deuterium-enriched hydrogen gas, light water (H₂O) contained in the raw material water decomposes first due to the isotope effect. Therefore, the content ratio of D to all hydrogen atoms in the resulting hydrogen gas is low immediately after the start of electrolysis and gradually increases over time. Conventionally, when producing deuterium-enriched hydrogen gas, the hydrogen gas generated before the target D content ratio was reached was discarded, resulting in a low recovery rate of hydrogen gas and high production costs.

Theoretically, if the entire amount of D contained in deuterium-enriched water (raw material water) injected into an electrolysis device could be converted into hydrogen gas, the content ratio of D to all hydrogen atoms in the ultimately obtained hydrogen gas would be equivalent to the content ratio of D to all hydrogen atoms in the raw material water. However, in actual operation of an electrolysis device, the electrodes must be immersed in the raw material water in the case of a batch-type electrolysis device such as that described in PTL 1, and a minimum amount of liquid must be secured to drive the liquid supply pump in the case of a flow-type electrolysis device. Raw material water thus inevitably remains in the electrolysis device. Therefore, it is impossible to electrolyze all of the raw material water that is injected. Also, taking into consideration the aforementioned phenomenon of changes over time, conventional hydrogen gas production methods have the problem that the content ratio of D to all hydrogen atoms in the resulting hydrogen gas is lower than the content ratio of D to all hydrogen atoms in the raw material water.

In view of the above problems, the present disclosure aims to provide a hydrogen gas production system and a hydrogen gas production method capable of producing, at a high recovery rate, hydrogen gas having a content ratio of deuterium D equal to or greater than the content ratio of deuterium D in all hydrogen atoms in raw material water.

### Solution to Problem

We have conducted extensive research to solve the above problems and have come to the following findings. By storing the hydrogen gas obtained from the electrolysis device in a reservoir, the content ratio of D in all hydrogen atoms in the hydrogen gas can be averaged over time. Furthermore, as a result of operation of the electrolysis device, the content ratio of D to all hydrogen atoms in the raw material water remaining in the device is higher than before the start of electrolysis. Therefore, by replenishing the electrolysis device with deuterium-enriched water (raw material water) as the amount of raw material water in the electrolysis device decreases, it is possible to continuously generate hydrogen gas with a higher content ratio of D. By combining these findings, hydrogen gas having a content ratio of D equal to or greater than the content ratio of D in all hydrogen atoms in the raw material water can be produced without discarding the generated hydrogen gas.

The primary features of the present disclosure are as follows.

[1] A hydrogen gas production system comprising:
a first tank to contain raw material water including heavy water;
an electrolysis device configured to electrolyze the raw material water to generate a hydrogen gas;
a reservoir to store the hydrogen gas;
a liquid supply device configured to supply the raw material water from the first tank to the electrolysis device; and
a gas supply device configured to supply the hydrogen gas generated in the electrolysis device to the reservoir,
wherein the liquid supply device is controlled to replenish the electrolysis device with the raw material water from the first tank as an amount of the raw material water remaining in the electrolysis device decreases, and
wherein the gas supply device is controlled to supply the hydrogen gas generated in the electrolysis device to the reservoir continuously before and after replenishing of the electrolysis device, and the reservoir stores the hydrogen gas generated in the electrolysis device before and after the replenishing.

[2] The hydrogen gas production system according to [1], wherein the electrolysis device comprises
an electrolytic cell in which an anode chamber containing an anode and a cathode chamber containing a cathode are adjacent to each other with an ion exchange membrane therebetween,
a second tank to contain the raw material water supplied from the first tank,
a liquid supply pipe connecting the second tank and the anode chamber to supply the raw material water from the second tank to the anode chamber,
a return pipe connecting the anode chamber and the second tank to return the raw material water from the anode chamber to the second tank, and
a circulation device configured to circulate the raw material water between the second tank and the anode chamber via the liquid supply pipe and the return pipe.

[3] A hydrogen gas production method comprising:
storing raw material water including heavy water in a first tank;
supplying the raw material water from the first tank to an electrolysis device;
electrolyzing, in the electrolysis device, the raw material water to generate a hydrogen gas; and
supplying the hydrogen gas generated in the electrolysis device to a reservoir,
wherein the electrolysis device is replenished with the raw material water from the first tank as an amount of the raw material water remaining in the electrolysis device decreases, and
wherein the hydrogen gas generated in the electrolysis device is supplied to the reservoir continuously before and after replenishing of the electrolysis device, and the reservoir stores the hydrogen gas generated in the electrolysis device before and after the replenishing.

[4] The hydrogen gas production method according to [3], wherein the electrolysis device comprises an electrolytic cell in which an anode chamber containing an anode and a cathode chamber containing a cathode are adjacent to each other with an ion exchange membrane therebetween, and a second tank to contain the raw material water supplied from the first tank, and
wherein in the electrolyzing, while the raw material water is supplied from the second tank to the anode chamber via a liquid supply pipe connecting the second tank and the anode chamber, the raw material water is returned from the anode chamber to the second tank via a return pipe connecting the anode chamber and the second tank, so as to circulate the raw material water between the second tank and the anode chamber via the liquid supply pipe and the return pipe.

### Advantageous Effect

According to the hydrogen gas production system and hydrogen gas production method of the present disclosure, hydrogen gas having a content ratio of deuterium D equal to or greater than the content ratio of deuterium D in all hydrogen atoms in the raw material water can be produced with a high recovery rate.

### BRIEF DESCRIPTION OF THE DRAWINGS

In the accompanying drawings:

FIG. 1 is a schematic diagram illustrating the device configuration of a hydrogen gas production system in one embodiment of the present disclosure;

FIG. 2 is a schematic diagram illustrating the device configuration of a hydrogen gas production system having a flow-type electrolysis device in one embodiment of the present disclosure;

FIG. 3 is a schematic diagram illustrating the device configuration of a hydrogen gas production system having a batch-type electrolysis device in one embodiment of the present disclosure; and

FIG. 4 is a graph illustrating the content ratio of D to all hydrogen atoms in the obtained hydrogen gas versus the operating time of the electrolysis device in a comparative example.

### DETAILED DESCRIPTION

Hereinafter, embodiments of a hydrogen gas production system and a hydrogen gas production method according to the present disclosure will be described. The embodiment described below is a specific example of the present disclosure, and the configuration of the present disclosure is not limited to this specific example.

### [Hydrogen Gas Production System and Hydrogen Gas Production Method]

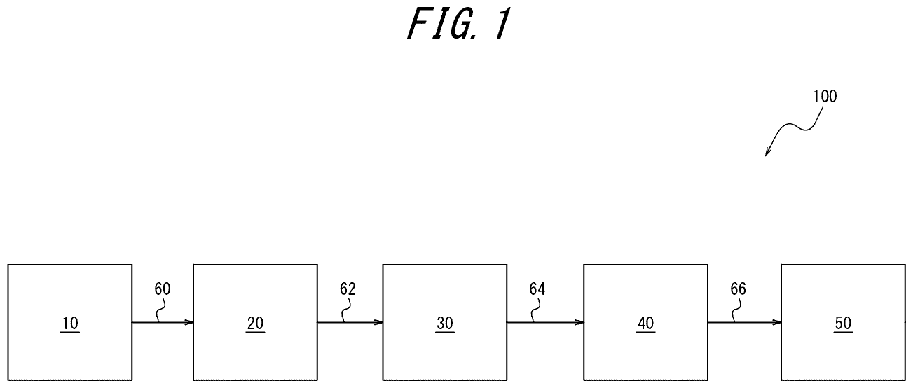

FIG. 1 illustrates the configuration of a hydrogen gas production system 100 in one embodiment of the present disclosure. The hydrogen gas production system 100 includes a first tank 10 to contain raw material water containing heavy water, an electrolysis device 30 that electrolyzes the raw material water to generate hydrogen gas, a reservoir 50 to store the hydrogen gas, a liquid supply device 20 that supplies the raw material water from the first tank 10 to the electrolysis device 30, and a gas supply device 40 that supplies the hydrogen gas generated in the electrolysis device 30 to the reservoir 50. The hydrogen gas production system 100 is further characterized in that the liquid supply device 20 is controlled to replenish the electrolysis device 30 with the raw material water from the first tank 10 as the amount of the raw material water remaining in the electrolysis device 30 decreases, the gas supply device 40 is controlled to supply the hydrogen gas generated in the electrolysis device 30 to the reservoir 50 continuously before and after the replenishing of the electrolysis device, and the reservoir 50 stores the hydrogen gas generated in the electrolysis device 30 before and after the replenishing.

In FIG. 1, a pipe 60 connects the first tank 10 and the liquid supply device 20 and defines a flow path through which the raw material water is supplied. A pipe 62 connects the liquid supply device 20 and the electrolysis device 30 and defines a flow path through which the raw material water is supplied. A pipe 64 connects the electrolysis device 30 and the gas supply device 40 and defines a flow path through which hydrogen gas is supplied. A pipe 66 connects the gas supply device 40 and the reservoir 50 and defines a flow path through which hydrogen gas is supplied.

A hydrogen gas production method according to one embodiment of the present disclosure can be suitably carried out using the hydrogen gas production system 100 and includes storing raw material water including heavy water in the first tank 10, supplying the raw material water from the first tank 10 to the electrolysis device 30, electrolyzing, in the electrolysis device 30, the raw material water to generate a hydrogen gas, and supplying the hydrogen gas generated in the electrolysis device 30 to the reservoir 50. The hydrogen gas production method is further characterized in that the electrolysis device 30 is replenished with the raw material water from the first tank 10 as the amount of the raw material water remaining in the electrolysis device 30 decreases, the hydrogen gas generated in the electrolysis device 30 is supplied to the reservoir 50 continuously before and after the replenishing of the electrolysis device, and the reservoir 50 stores the hydrogen gas generated in the electrolysis device 30 before and after the replenishing.

### (Raw Material Water)

The raw material water is water containing heavy water (D₂O). When the content ratio of D to all hydrogen atoms in the raw material water (deuterium-enriched water) is 90 [atom % D] or more, hydrogen gas in which D is sufficiently concentrated can be obtained, which is preferable. Although there is no particular upper limit on the content ratio of D to all hydrogen atoms in the raw material water (deuterium-enriched water), from an industrial viewpoint, the content ratio of D to all hydrogen atoms in the raw material water (deuterium-enriched water) is generally 99.98 [atom % D] or less. The raw material water may contain a portion of semiheavy water (HDO), and the D contained in semiheavy water is also included in the above content ratio. Furthermore, depending on the electrolysis device used, the raw material water may contain a supporting salt such as potassium hydroxide or hypochlorite.

The content ratio of D to all hydrogen atoms in the raw material water can be determined by subjecting the raw material water to analysis using a nuclear magnetic resonance spectrometer (for example, manufactured by JEOL Ltd.), measuring the areas of H atoms and D atoms, and calculating the ratio of the area of D atoms to the total area of H atoms and D atoms.

### (First Tank 10)

The first tank 10 is a device for containing raw material water and is connected to the liquid supply device 20 by the pipe 60. The material of the first tank 10 is not particularly limited, but materials that are easily permeable to air components, such as resin, may allow moisture in the air to pass through, thereby reducing the content ratio of D in all hydrogen atoms in the raw material water in the first tank 10. Therefore, it is preferable to use SUS or glass material that are not permeable to air components.

### (Liquid Supply Device 20 and Liquid Supply Process)

The liquid supply device 20 is a device that supplies the raw material water from the first tank 10 to the electrolysis device 30 and is connected to the first tank 10 by the pipe 60 and to the electrolysis device 30 by the pipe 62. The liquid supply device 20 may be, for example, a liquid supply pump. The liquid supply process is a process of supplying raw material water from the first tank 10 to the electrolysis device 30 using the liquid supply device 20. The amount of water in the electrolysis device 30 is increased by supplying the raw material water so that the electrolysis device 30 can operate. The amount of liquid to be supplied is preferably set to the upper limit of the amount that can be contained in the electrolysis device 30.

The liquid supply device 20 is controlled to replenish the electrolysis device 30 with the raw material water from the first tank 10 as the amount of the raw material water remaining in the electrolysis device 30 decreases during the process of electrolysis of raw material water by the electrolysis device 30. The control for replenishing the raw material water is not limited, but the following mode is preferred. The electrolysis device 30 is preferably provided with a liquid level sensor. The liquid level sensor detects the liquid level of the raw material water in the electrolysis device 30 (i.e., the amount of remaining raw material water) and outputs a signal when the liquid level drops to a predetermined threshold. The output signal of the liquid level sensor is transmitted to a controller (such as a CPU). The controller operates the liquid supply device 20 upon receiving the signal from the liquid level sensor and replenishes the electrolysis device 30 with the raw material water. Alternatively, the output signal from the liquid level sensor may be in the form of light, sound, or the like, and an operator may recognize the output signal from the liquid level sensor and operate the liquid supply device 20 to replenish the electrolysis device 30 with the raw material water.

In a case in which a liquid level sensor such as the one described above is installed in the electrolysis device 30, the timing for replenishing with the raw material water is preferably when the liquid level falls to a predetermined threshold. Here, the threshold of the liquid level may be the liquid level at the operational limit of the electrolysis device 30, as described later, or may be set to a value higher than the operational limit so that the raw material water can be added before the operational limit is reached. In a case in which a liquid level sensor is not installed in the electrolysis device 30, an operator may periodically check the liquid level, and if it is determined that the liquid level is decreasing, the liquid supply device 20 may be operated to replenish the electrolysis device 30 with the raw material water. The consumption rate of raw material water can be determined by the capacity of the electrolysis device 30, the electrolysis conditions, and the like. The consumption amount of the raw material water can therefore be calculated in advance, and after electrolysis has been performed for a certain period of time, the controller can operate the liquid supply device 20 automatically, or an operator can operate the liquid supply device 20 to replenish the electrolysis device 30 with the raw material water. The timing for replenishing the electrolysis device 30 with the raw material water is not particularly limited, and replenishing may be performed constantly during electrolysis.

When the electrolysis device 30 generates hydrogen gas, light water (H₂O) contained in the raw material water is decomposed first due to the isotope effect. Therefore, the content ratio of D to all hydrogen atoms in the raw material water remaining in the electrolysis device 30 increases over time. During the process of electrolysis of raw material water by the electrolysis device 30, the electrolysis device 30 is replenished with the raw material water by the liquid supply device 20, thus enabling the electrolysis device 30 to electrolyze raw material water having a higher content ratio of D. As a result, hydrogen gas having a higher content ratio of D than the hydrogen gas obtained before replenishing with the raw material water is obtained.

### (Pipes 60, 62)

The hydrogen gas production system 100 includes the pipe 60 that connects the first tank 10 and the liquid supply device 20 and defines a flow path through which the raw material water is supplied from the first tank 10 to the liquid supply device 20. The hydrogen gas production system 100 further includes the pipe 62 that connects the liquid supply device 20 and the electrolysis device 30 and defines a flow path through which the raw material water is supplied from the liquid supply device 20 to the electrolysis device 30. The material of the pipes 60, 62 is not particularly limited, but materials that are easily permeable to air components, such as resin, may allow moisture in the air to pass through, thereby reducing the content ratio of D in all hydrogen atoms in the raw material water in the pipes 60, 62. Therefore, it is preferable to use SUS or glass material that are not permeable to air components.

### (Electrolysis Device 30)

The electrolysis device 30 is a device that electrolyzes the raw material water and is connected to the liquid supply device 20 by the pipe 62 and to the gas supply device 40 by the pipe 64. The electrolysis device 30 is not particularly limited as long as it can electrolyze raw material water to generate hydrogen gas, and any conventionally known electrolysis device can be used. Generally, two types of electrolysis devices 30 are widely used: a flow type and a batch type.

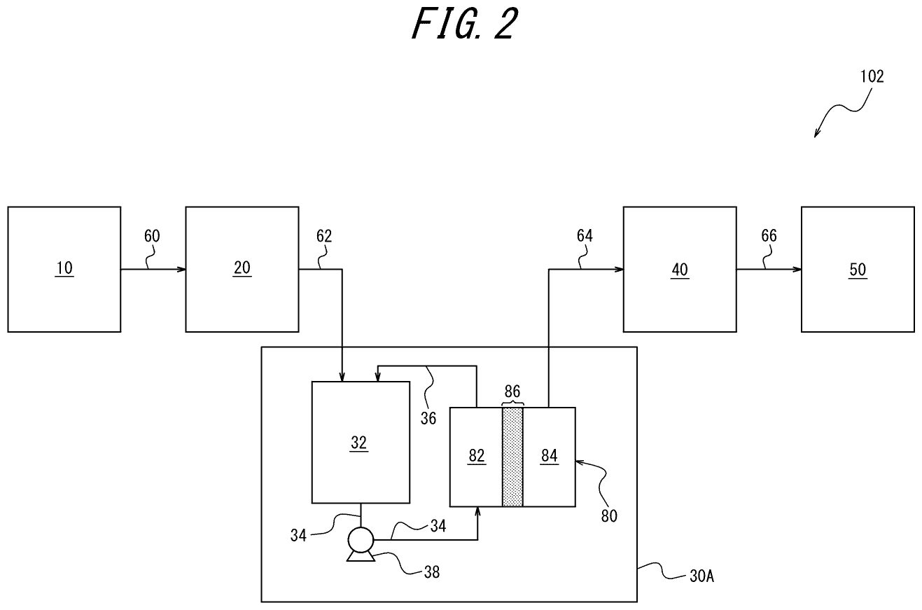

FIG. 2 illustrates a schematic diagram of a hydrogen gas production system 102 having a flow-type electrolysis device 30A in one embodiment of the present disclosure. The configuration other than the electrolysis device 30A is the same as that illustrated in FIG. 1. The electrolysis device 30A has an electrolytic cell 80, and the electrolytic cell 80 has a configuration in which an anode chamber 82 containing an anode and a cathode chamber 84 containing a cathode are adjacent to each other with an ion exchange membrane 86 therebetween. Furthermore, the electrolysis device 30A includes a second tank 32 to contain the raw material water supplied from the first tank 10 by the liquid supply device 20 and a circulation device 38 that circulates the raw material water between the second tank 32 and the anode chamber 82 via a liquid supply pipe 34 and a return pipe 36. The liquid supply pipe 34 connects the second tank 32 and the anode chamber 82 and is a pipe for supplying the raw material water from the second tank 32 to the anode chamber 82. The return pipe 36 connects the second tank 32 and the anode chamber 82 and is a pipe for returning the raw material water from the anode chamber 82 to the second tank 32. The circulation device 38 may be, for example, a liquid pump. The location where the circulation device 38 is installed is not particularly limited, but as illustrated in FIG. 2, the circulation device 38 is installed in the liquid supply pipe 34, for example.

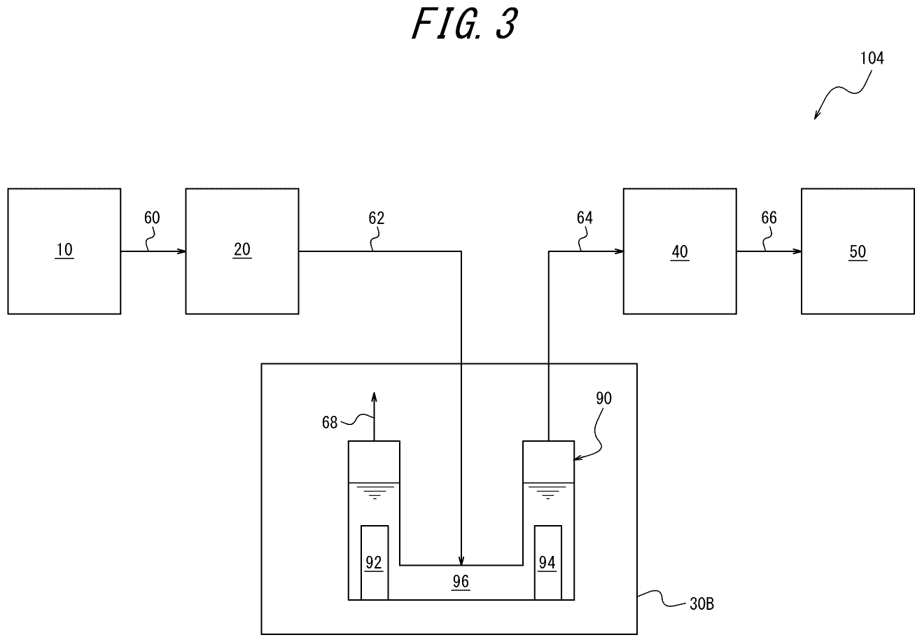

FIG. 3 illustrates a schematic diagram of a hydrogen gas production system 104 having a batch-type electrolysis device 30B in one embodiment of the present disclosure. The configuration other than the electrolysis device 30B is the same as that illustrated in FIG. 1. The electrolysis device 30B has an electrolytic cell 90 containing an anode 92 and a cathode 94, and the anode 92 and the cathode 94 are immersed in raw material water 96 also contained in the electrolytic cell 90. A pipe 68 is used to discharge oxygen gas produced as a by-product at the anode 92 of the electrolytic cell 90.

### (Electrolysis Process)

The electrolysis process is a process of generating hydrogen gas using the electrolysis device 30. In a case in which the flow-type electrolysis device 30A illustrated in FIG. 2 is used, the circulation device 38 is preferably operated at all times during electrolysis to circulate the raw material water between the second tank 32 and the anode chamber 82.

In a case in which electrolysis is performed using the flow-type electrolysis device 30A illustrated in FIG. 2, raw material water is decomposed into oxygen gas and hydrogen ions in the anode chamber 82 of the electrolytic cell 80 by the oxidation reaction illustrated in the following formula (1). The hydrogen ions generated in the anode chamber 82 permeate the ion exchange membrane 86 and move to the cathode chamber 84, where they are converted into hydrogen gas by the reduction reaction illustrated in the following formula (2). The hydrogen gas generated in the cathode chamber 84 is supplied by the gas supply device 40 through the pipes 64, 66 to the reservoir 50. Although most of the oxygen gas generated in the anode chamber 82 does not pass through the ion exchange membrane 86, the very small amount of oxygen gas that does pass through reacts with hydrogen ions under the reducing conditions in the cathode chamber 84 to form water, and is therefore not included in the hydrogen gas generated in the cathode chamber 84.

H₂O→1/2O₂+2H⁺+2e⁻ (1)

2H⁺+2e⁻→H₂ (2)

The hydrogen gas obtained by electrolysis of heavy water (D₂O) is deuterium gas (D₂). Furthermore, when the raw material water contains semiheavy water (HDO), the hydrogen gas obtained by electrolysis of the semiheavy water contains semiheavy hydrogen gas (HD). When the raw material water is deuterium-enriched water, the resulting hydrogen gas is also deuterium-enriched hydrogen gas (hydrogen gas containing a higher proportion of deuterium D than normal hydrogen gas).

Similarly, in a case in which the batch-type electrolysis device 30B illustrated in FIG. 3 is used, the oxidation reaction illustrated in the above formula (1) occurs at the anode 92 in the electrolytic cell 90, and the reduction reaction illustrated in the above formula (2) occurs at the cathode 94. The electrolytic cell 90 does not have the ion exchange membrane 86 but has spaces above the anode and cathode sides, as illustrated in FIG. 3. By adopting such a structure, the oxygen gas generated at the anode 92 and the hydrogen gas generated at the cathode 94 do not mix with each other, the oxygen gas moves to the space above the anode 92, and the hydrogen gas moves to the space above the cathode 94. The hydrogen gas is supplied to the reservoir 50 by the gas supply device 40 via the pipes 64, 66. The oxygen gas produced as a by-product at the anode 92 of the electrolytic cell 90 is discharged via the pipe 68.

Once the electrolysis process is started when the electrolysis device 30 contains the raw material water up to the upper limit, the raw material water in the electrolysis device 30 decomposes and gradually decreases. Therefore, during the process of electrolysis of the raw material water by the electrolysis device 30, as the amount of raw material water remaining in the electrolysis device 30 decreases, the liquid supply device 20 replenishes the electrolysis device 30 with the raw material water from the first tank 10. The electrolysis device 30 is replenished with the raw material water before the amount of raw material water remaining in the electrolysis device 30 reaches the liquid amount that is the operational limit of the electrolysis device 30. The operational limit refers to a state in which, in the case of the flow-type electrolysis device 30A, the minimum amount of raw material water required to drive the circulation device 38 has been reached, or, in the case of the batch-type electrolysis device 30B, the amount of liquid has reached such a level that the anode 92 or the cathode 94 is above the liquid surface of the raw material water.

When hydrogen gas is generated in the electrolysis process, light water (H₂O) contained in the raw material water is decomposed first due to the isotope effect. Therefore, the content ratio of D to all hydrogen atoms in the raw material water remaining in the electrolysis device 30 increases over time. During the process of electrolysis of raw material water by the electrolysis device 30, the electrolysis device 30 is replenished with the raw material water by the liquid supply device 20, thus enabling the electrolysis device 30 to electrolyze raw material water having a higher content ratio of D. As a result, hydrogen gas having a higher content ratio of D than the hydrogen gas obtained before replenishing with the raw material water is obtained.

### (Gas Supply Device 40)

The gas supply device 40 is a device that supplies hydrogen gas from the electrolysis device 30 to the reservoir 50 and is connected to the electrolysis device 30 by the pipe 64 and to the reservoir 50 by the pipe 66. The gas supply device 40 is controlled to continuously supply the hydrogen gas generated in the electrolysis device 30 to the reservoir 50 before and after the liquid supply device 20 replenishes the electrolysis device 30 with the raw material water. A booster may be used as the gas supply device 40.

### (Gas Supply Process)

The gas supply process is a process of supplying the hydrogen gas generated in the electrolysis device 30 to the reservoir 50 using the gas supply device 40. The supply of gas to the reservoir 50 is carried out continuously before and after the liquid supply device 20 replenishes the electrolysis device 30 with the raw material water. As a result, the content ratio of D to all hydrogen atoms in the continuously obtained hydrogen gas is averaged in the hydrogen gas stored in the reservoir 50. The hydrogen gas generated in the electrolysis device 30 generally has a pressure of about 0.3 MPa. Therefore, an example of the gas supply process can be as follows. The pressure inside the reservoir 50 is reduced before the electrolysis device 30 is operated. Immediately after the electrolysis device 30 is operated, the generated hydrogen gas is filled into the reservoir 50 under its own pressure. The hydrogen gas is then further pressurized by the gas supply device 40 to fill the reservoir 50.

### (Pipe 64)

The hydrogen gas production system 100 has the pipe 64 that connects the electrolysis device 30 and the gas supply device 40 and defines a flow path through which hydrogen gas is supplied from the electrolysis device 30 to the gas supply device 40. The material of the pipe 64 is not particularly limited, but materials that are easily permeable to air components, such as resin, will lead to a decrease in the purity of the resulting hydrogen gas. Therefore, it is preferable to use SUS or glass material that are not permeable to air components.

In addition, in the flow paths that supply the hydrogen gas generated from the electrolysis device 30 to the reservoir 50, devices such as a mass flow controller or a back pressure valve that control the amount of hydrogen gas supplied, a purifier that removes moisture and air components from the generated hydrogen gas, a compressor that pressurizes the generated hydrogen gas, and the like may be appropriately installed.

### (Reservoir 50)

The reservoir 50 is a device for storing hydrogen gas obtained by electrolysis and is connected to the gas supply device 40 by the pipe 66. The reservoir 50 is configured to continuously store the hydrogen gas generated in the electrolysis device 30 before and after the liquid supply device 20 replenishes the electrolysis device 30 with the raw material water. By continuous storage of hydrogen gas in the reservoir 50, the content ratio of D to all hydrogen atoms in the stored hydrogen gas is averaged.

The material of the reservoir 50 is not particularly limited, but materials that are easily permeable to air components, such as resin, will lead to a decrease in the purity of the resulting hydrogen gas. Therefore, it is preferable to use SUS or glass material that are not permeable to air components.

### (Pipe 66)

The hydrogen gas production system 100 has the pipe 66 that connects the gas supply device 40 and the reservoir 50 and defines a flow path through which hydrogen gas is supplied from the gas supply device 40 to the reservoir 50. The material of the pipe 66 is not particularly limited, but materials that are easily permeable to air components, such as resin, will lead to a decrease in the purity of the resulting hydrogen gas. Therefore, it is preferable to use SUS or glass material that are not permeable to air components.

### (Hydrogen Gas)

According to the hydrogen gas production system and hydrogen gas production method of the embodiment of the present disclosure described above, hydrogen gas having a content ratio of deuterium D equal to or greater than the content ratio of deuterium D to all hydrogen atoms in the raw material water (deuterium-enriched water) can be obtained without discarding the hydrogen gas generated in the initial stage. In particular, the content ratio of D to all hydrogen atoms in the raw material water is preferably 90 [atom % D] or more, since hydrogen gas having a content ratio of D to all hydrogen atoms in the raw material water of 90 [atom % D] or more can be obtained. No particular upper limit is placed on the content ratio of D to all hydrogen atoms in the hydrogen gas, and the content ratio of D to all hydrogen atoms in the hydrogen gas can be 100.00 [atom % D] or less. As described above, from an industrial viewpoint, the upper limit of the content ratio of D to all hydrogen atoms in the raw material water is 99.98 [atom % D]. In this case, the content ratio of D to all hydrogen atoms in the obtained hydrogen gas can be 99.98 [atom % D] or more. The hydrogen gas may also contain a portion of semiheavy hydrogen gas (HD), and D contained in semiheavy water is also included in the above content ratio. The content ratio of D to all hydrogen atoms in hydrogen gas can be determined in the same manner as for the raw material water.

For processes and conditions not described in the present disclosure, standard methods can be used.

### EXAMPLES

### Example 1

Using an apparatus having the same configuration as the one illustrated in FIG. 2, 940 g of raw material water (deuterium-enriched water) having a content ratio of D of 99.84 atom % D was initially injected into the electrolysis device, and the first operation of the apparatus was started. Six hours after the start of operation, the content ratio of D of the hydrogen gas stored in the reservoir was measured and found to be 99.81 atom % D. At this time, 400 g of raw material water remained in the electrolysis device, and the content ratio of D in the remaining raw material water was 99.92 atom % D.

Next, 540 g of raw material water having a content ratio of D of 99.84 atom % D was injected from the first tank to adjust the content ratio of D of the raw material water in the electrolysis device to 99.87 atom % D, and the second operation of the device was started to generate hydrogen gas. Six hours after the start of operation, the content ratio of D of the hydrogen gas stored in the reservoir was measured and found to be 99.83 atom % D. At this time, 400 g of raw material water remained in the electrolysis device, and the content ratio of D in the remaining raw material water was 99.95 atom % D.

Therefore, 540 g of raw material water having a content ratio of D of 99.84 atom % D was similarly injected from the first tank to adjust the content ratio of D of the raw material water in the electrolysis device to 99.88 atom % D, and the third operation of the device was started to generate hydrogen gas. Six hours after the start of operation, the content ratio of D of the hydrogen gas stored in the reservoir was measured and found to be 99.84 atom % D. At this time, 400 g of raw material water remained in the electrolysis device, and the content ratio of D in the remaining raw material water was 99.95 atom % D.

Furthermore, 540 g of raw material water having a content ratio of D of 99.84 atom % D was similarly injected from the first tank to adjust the content ratio of D of the raw material water in the electrolysis device to 99.88 atom % D, and the fourth operation of the device was started to generate hydrogen gas. Six hours after the start of operation, the content ratio of D of the hydrogen gas stored in the reservoir was measured and found to be 99.85 atom % D. At this time, 400 g of raw material water remained in the electrolysis device, and the content ratio of D in the remaining raw material water was 99.95 atom % D. Table 1 illustrates the measurement results.

The recovery rate of hydrogen gas generated from the electrolysis device as hydrogen gas having a content ratio of D equal to or greater than the content ratio of D in all hydrogen atoms in the raw material water in the reservoir was ≥99%. The recovery rate was calculated as follows.

Recovery rate [%]=(amount of hydrogen gas recovered in the reservoir [L]/total amount of hydrogen gas generated by the electrolysis device [L])×100[%]

TABLE 1

| | Content ratio of D in raw | | |
|---|---|---|---|
| | material water in electrolysis | | Content ratio of |
| | device [atom % D] | | D in hydrogen |
| Cycle number of | At start of | | gas in the |
| hydrogen gas | operation (after | Residual | reservoir after |
| generation (6 | charging from | water after | each cycle |
| hours per cycle) | first tank) | each cycle | [atom % D] |
| First | 99.84 | 99.92 | 99.81 |
| Second | 99.87 | 99.95 | 99.83 |
| Third | 99.88 | 99.95 | 99.84 |
| Fourth | 99.88 | 99.95 | 99.85 |

### Example 2

Using an apparatus having the same configuration as the one illustrated in FIG. 3, 100 g of raw material water (deuterium-enriched water) having a content ratio of D of 99.84 atom % D was initially injected into the electrolysis device, and the first operation of the apparatus was started. One hour after the start of operation, the content ratio of D of the hydrogen gas stored in the reservoir was measured and found to be 99.83 atom % D. At this time, 12 g of raw material water remained in the electrolysis device, and the content ratio of D in the remaining raw material water was 99.97 atom % D.

Next, 88 g of raw material water having a content ratio of D of 99.84 atom % D was injected from the first tank to adjust the content ratio of D of the raw material water in the electrolysis device to 99.85 atom % D, and the second operation of the device was started to generate hydrogen gas. One hour after the start of operation, the content ratio of D of the hydrogen gas stored in the reservoir was measured and found to be 99.84 atom % D. At this time, 12 g of raw material water remained in the electrolysis device, and the content ratio of D in the remaining raw material water was 99.97 atom % D.

Therefore, 88 g of raw material water having a content ratio of D of 99.84 atom % D was similarly injected from the first tank to adjust the content ratio of D of the raw material water in the electrolysis device to 99.85 atom % D, and the third operation of the device was started to generate hydrogen gas. One hour after the start of operation, the content ratio of D of the hydrogen gas stored in the reservoir was measured and found to be 99.85 atom % D. At this time, 12 g of raw material water remained in the electrolysis device, and the content ratio of D in the remaining raw material water was 99.97 atom % D. Table 2 illustrates the measurement results.

The recovery rate was calculated in the same manner as in Example 1. The recovery rate of hydrogen gas generated from the electrolysis device as hydrogen gas having a content ratio of D equal to or greater than the content ratio of D in all hydrogen atoms in the raw material water in the reservoir was ≥99%.

TABLE 2

| | Content ratio of D in raw | | |
|---|---|---|---|
| | material water in electrolysis | | Content ratio of |
| | device [atom % D] | | D in hydrogen |
| Cycle number of | At start of | | gas in the |
| hydrogen gas | operation (after | Residual | reservoir after |
| generation (1 | charging from | water after | each cycle |
| hour per cycle) | first tank) | each cycle | [atom % D] |
| First | 99.84 | 99.97 | 99.83 |
| Second | 99.85 | 99.97 | 99.84 |
| Third | 99.85 | 99.97 | 99.85 |

### Comparative Example 1

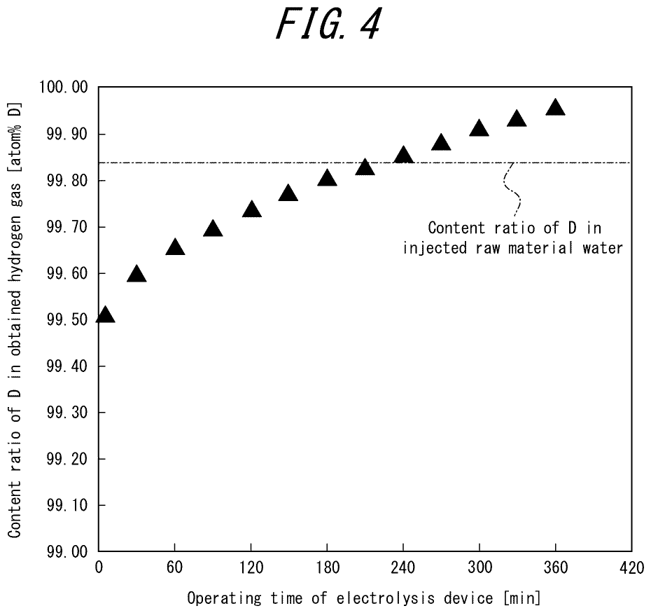

The electrolysis device was used without using the first tank and the reservoir among the devices used in Example 1, and raw material water (deuterium-enriched water) having a D content of 99.84 atom % D was electrolyzed. The generated hydrogen gas was sampled periodically to measure the D content. FIG. 4 illustrates the content ratio of D to all hydrogen atoms in the obtained hydrogen gas versus the operating time of the electrolysis device. As a result, it took 3.8 hours or more of operation for the content ratio of D of the generated hydrogen gas to reach 99.84 atom % D, which is the content ratio of D in the raw material water. That is, if a reservoir is not used, in order to obtain hydrogen gas with a content ratio of D of 99.84 atom % D, the 3.8 hours' worth of hydrogen gas before reaching 99.84 atom % D must be discarded. Assuming that 3.8 hours' worth of hydrogen gas was discarded, the recovery rate was calculated in the same manner as in Example 1. The recovery rate of hydrogen gas having a content ratio of D equal to or greater than the content ratio of D in all hydrogen atoms in the raw material water in the reservoir was 37%.

### REFERENCE SIGNS LIST

100 Hydrogen gas production system
102 Hydrogen gas production system having a flow-type electrolysis device
104 Hydrogen gas production system having a batch-type electrolysis device
10 First tank
20 Liquid supply device
30 Electrolysis device
30A Flow-type electrolysis device
30B Batch-type electrolysis device
32 Second tank
34 Liquid supply pipe
36 Return pipe
38 Circulation device
40 Gas supply device
50 Reservoir
60 Pipe
62 Pipe
64 Pipe
66 Pipe
68 Pipe
80 Flow-type electrolysis cell
82 Anode chamber
84 Cathode chamber
86 Ion exchange membrane
90 Batch-type electrolytic cell
92 Anode
94 Cathode
96 Raw material water

1. A hydrogen gas production system comprising:
a first tank to contain raw material water including heavy water;
an electrolysis device configured to electrolyze the raw material water to generate a hydrogen gas;
a reservoir to store the hydrogen gas;
a liquid supply device configured to supply the raw material water from the first tank to the electrolysis device; and
a gas supply device configured to supply the hydrogen gas generated in the electrolysis device to the reservoir,
wherein the liquid supply device is controlled to replenish the electrolysis device with the raw material water from the first tank as an amount of the raw material water remaining in the electrolysis device decreases, and
wherein the gas supply device is controlled to supply the hydrogen gas generated in the electrolysis device to the reservoir continuously before and after replenishing of the electrolysis device, and the reservoir stores the hydrogen gas generated in the electrolysis device before and after the replenishing.

2. The hydrogen gas production system according to claim 1, wherein the electrolysis device comprises
an electrolytic cell in which an anode chamber containing an anode and a cathode chamber containing a cathode are adjacent to each other with an ion exchange membrane therebetween,
a second tank to contain the raw material water supplied from the first tank,
a liquid supply pipe connecting the second tank and the anode chamber to supply the raw material water from the second tank to the anode chamber,
a return pipe connecting the anode chamber and the second tank to return the raw material water from the anode chamber to the second tank, and
a circulation device configured to circulate the raw material water between the second tank and the anode chamber via the liquid supply pipe and the return pipe.

3. A hydrogen gas production method comprising:
storing raw material water including heavy water in a first tank;
supplying the raw material water from the first tank to an electrolysis device;
electrolyzing, in the electrolysis device, the raw material water to generate a hydrogen gas; and
supplying the hydrogen gas generated in the electrolysis device to a reservoir,
wherein the electrolysis device is replenished with the raw material water from the first tank as an amount of the raw material water remaining in the electrolysis device decreases, and
wherein the hydrogen gas generated in the electrolysis device is supplied to the reservoir continuously before and after replenishing of the electrolysis device, and the reservoir stores the hydrogen gas generated in the electrolysis device before and after the replenishing.

4. The hydrogen gas production method according to claim 3, wherein the electrolysis device comprises an electrolytic cell in which an anode chamber containing an anode and a cathode chamber containing a cathode are adjacent to each other with an ion exchange membrane therebetween, and a second tank to contain the raw material water supplied from the first tank, and
wherein in the electrolyzing, while the raw material water is supplied from the second tank to the anode chamber via a liquid supply pipe connecting the second tank and the anode chamber, the raw material water is returned from the anode chamber to the second tank via a return pipe connecting the anode chamber and the second tank, so as to circulate the raw material water between the second tank and the anode chamber via the liquid supply pipe and the return pipe.
